(19) United States
(12) Patent Application Publication
(10) Pub. No.: US 2014/0274018 A1
(43) Pub. Date: Sep. 18, 2014

(54) SAFETY ENHANCING CELLPHONE FUNCTIONALITY LIMITATION SYSTEM

(71) Applicant: Alan Miller, Bohemia, NY (US)

(72) Inventor: Alan Miller, Bohemia, NY (US)

(21) Appl. No.: 13/844,409

(22) Filed: Mar. 15, 2013

(51) Int. Cl. H04W 4/04; H04W 8/22

(52) U.S. Cl. CPC H04W 4/046; H04W 8/22
USPC 455/418

(57) ABSTRACT

Apparatus for the management of mobile telephone device functionality while the mobile telephone device is located within a vehicle, comprising a plurality of wireless sensors is disclosed. Each of the sensors receives position indicating signals emitted by the mobile telephone device, and the signals indicating the position of each sensor relative to the mobile telephone device, the wireless sensors being positioned at different positions in the car. A transmitter transmits a signal to the mobile telephone device, causing the mobile telephone device to transmit the position indicating signals to the sensors. A software algorithm resident on a storage device associated with the computational logic unit controls the functionality of the mobile telephone device in response to the position of the mobile telephone device within the vehicle and the speed of the vehicle.

### TECHNICAL FIELD

The invention relates to apparatus and methods for limiting cell phone functionality in situations, such as automobile operation, where use may present a safety hazard.

### CROSS REFERENCE TO RELATED APPLICATIONS

(Not applicable).

### STATEMENT REGARDING FEDERALLY SPONSORED RESEARCH OR DEVELOPMENT

(Not applicable)

### BACKGROUND OF THE INVENTION

There is an extensive body of law regulating the use of cellular telephones, texting devices, e-mail devices and the like by the operator of an vehicle during operation of the vehicle. There is also data which indicates that operation of a texting device, for example, or use of a cellular telephone, during operation of vehicle may lead to an increased likelihood of an accident occurring.

### SUMMARY OF THE INVENTION

In accordance with the invention, a system is provided whereby various cellular telephone or smartphone functionalities may be disabled upon the detection of a dangerous condition. More particularly, in accordance with the invention, texting, e-mail or other functions may be selectively disabled depending upon cell phone position and/or other conditions signaled by cell phone position. For example, depending upon either user selection, supervisor selection (for example, a company may wish to induce a likelihood of an accident by regulating cell phone usage in accordance with company policy) or in accordance with guidelines dictated by a cell phone provider or government regulation.

In accordance with the invention, when the inventive software in the cell phone detects that the cell phone is positioned within the driver's zone, that is the area where the driver is normally situated while the car is being driven, the system will disable the cell phone, for example by only disabling the display. In accordance with the invention, if the cell phone is not within the driver's zone, the screen display will not be disabled. The amount of enablement or disablement of the cell phone may vary in accordance with system settings. For example, users can use their cell phones to answer calls, but will be prevented from viewing images on the screen. Cellular telephones not in the driver's zone may operate with limited restrictions or no restrictions at all. For example, in accordance with the invention, cellular telephones not in the driver's zone may have complete screen enablement. Moreover, cellular telephones within the driver's zone will have their screens disabled.

If desired, a cellular telephone may be enabled as soon as it is positioned within a space which is not within the driver's zone. Alternatively, the system may require that a sequence of keys should be pressed in order to activate the phone. For example, this may be permitted only when the cellular telephone has been out of the driver's zone for a period of time, for example 30 seconds. It is also contemplated in accordance with the invention that such requests for activation of the phone may be stored, optionally with positional information.

It is contemplated that cellular telephones may be moved in and out of the driver's zone. When a telephone is moved into the driver's zone, the screen will be disabled. Conversely, when a cell phone moves out of the driver's zone, the screen will be enabled.

Apparatus for the management of mobile telephone device functionality while the mobile telephone device is located within a vehicle, comprising a plurality of wireless sensors is disclosed. Each of the sensors receives position indicating signals emitted by the mobile telephone device, and the Mets signals indicating the position of each sensor relative to the mobile telephone device, the wireless sensors being positioned at different positions in the period a transmitter transmits a signal to the mobile telephone device, causing the mobile telephone device to transmit the position indicating signals to the sensors. A processor is coupled to receive the signals indicating the position of each sensor relative to the mobile telephone device. The processor comprises a computational logic unit and a data storage device for storing software for computing the position of the mobile telephone device. A channel is used for coupling the signals indicating the position of each sensor relative to the mobile telephone device. The computational logic unit calculates the position of the mobile telephone device in the vehicle. A signal source generates a signal indicative of the state of operation of the vehicle and couples the same to the computational logic unit. A software algorithm resident on a storage device associated with the computational logic unit controls the functionality of the mobile telephone device in response to the position of the mobile telephone device within the vehicle and the speed of the vehicle.

### BRIEF DESCRIPTION THE DRAWINGS

The operation of the invention will become apparent from the following description taken in conjunction with the drawings, in which:

FIG. 1 is a an overview illustrating an implementation of the present invention;

FIG. 2 is a view of an automobile dashboard illustrating the placement of principal components of the present invention;

FIG. 3 schematically illustrates the geometrical issues involved in triangulation using information respecting the distance between a cellular telephone and three sensors capable of providing distance information;

FIG. 4 is a diagram illustrating an exemplary embodiment of a cellular telephone disablement system in which a matrix of horizontally and vertically positioned sensors identify cell phones located in a plurality of horizontally oriented and vertically oriented areas in an automobile, with the intersection of horizontal and vertical areas corresponding to a positive indication of a cell phone's presence in such intersected area, providing a positive indication of the presence of the cell phone in the area of intersection, as implemented according to the present invention;

FIG. 5 is a block diagram of one embodiment of the present invention;

FIG. 6 is a flowchart illustrating the methodology of the present invention;

FIG. 7 illustrates an alternative embodiment of the present invention in block diagram form;

FIG. 8 is a somewhat more detailed block diagram of another alternative embodiment of the present invention particularly suited for inclusion in an automobile during manufacture;

FIG. 9 illustrates still another alternative embodiment of the present invention, suitable for retrofitting an existing automobile, or being incorporated into the manufacture of a vehicle if wireless functionality is desired; and

FIG. 10 illustrates yet another alternative, where functionality is resident on software in the mobile telephone device.

### DETAILED DESCRIPTION OF THE PREFERRED EMBODIMENTS

Referring to FIG. 1-3, an overview of the inventive vehicular cell phone sensor interface and safety system may be understood. As shown in FIG. 1, a vehicular cell phone sensor interface and safety system 2 takes the form of a vehicle network. This vehicle network comprises a plurality of sensors 4. Each of the sensors 4 communicates with a cell phone 6 (and potentially a number of cell phones) within the car.

Communication between each sensor and the cell phone may be done using any one of a number of potential communications channels. For example, such communication may be done via the Bluetooth transceiver located within the cell phone. In so far as this hardware is included in most cellular telephones and smart phones on the market today, this particular means of communication is of particular advantage, in so far as it imposes no further hardware cost upon the manufacturer of the telephone. However, it is necessary to include additional software in the telephone to provide the Bluetooth function of communicating with sensors 4.

In accordance with the invention, it is contemplated that communication with multiple sensors 4 may be accomplished by time multiplexing the Bluetooth channel. Of course, if hardware changes are an option in the design of the system, frequency multiplexed communications may also be considered.

The vehicle network referred to above further includes a central safety system control module 8. Control module 8 communicates with sensors for and cellular telephone 6 (FIG. 3). Control module 8 includes a CPU and also further includes interfaces for receiving particular information, such as vehicle speed, GPS location information, and the like. Optionally, control module 8 (FIG. 2) may communicate with sensors 4.

The vehicular cell phone sensor interface and safety system 2, comprising sensors 4 and module 8, and cooperating with cellular telephone 6 gathers real-time position information specifying the position of cell phone 6. This is done through the use of signal triangulation methods involving the transmission of electromagnetic signals 7, for example over a Bluetooth channel.

Such screening triangulation methods may take a number of forms. For example, one may use as few as two sensors, for example one in the back of the car on the driver's side of the vehicle, having a narrow angular detection range limited to the detection of Bluetooth signals coming from the area of the driver's seat. A second cooperating with Bluetooth sensor may be located adjacent the front passenger seat window and have a narrow angular detection range limited to the detection of Bluetooth signals coming from the area of the driver's seat. This accordingly results in a situation where both of these sensors will detect the presence of cellular telephone 6 only when it is in the vicinity of the driver's seat.

In connection with this, it is important that detection should be effective for a variety of positions of the cellular telephone. More particularly, the cell phone must be detected if it is adjacent to left or right ear of the driver, or if it is being held away from the head of the driver by a right or left hand, or whereever the driver may be holding it.

In accordance with the invention, it is also contemplated that more precise positional information may be gathered. In particular, sensors 4 may be equipped to detect the strength of the Bluetooth signal produced by cellular telephone 6. This effected signal strength is proportional to the distance between the sensor and the cellular telephone. This effected distance may then be encoded into a digital signal strength signal and transmitted from the detector to module 8. Module 8 then takes this information and using standard triangulation calculating techniques determines the position of the cell phone.

Accordingly, the inventive system may be implemented with either distance measuring techniques, such as signal strength measuring techniques as described above, or through the use of directional transmission signals, as more fully appears below. Still yet another alternative is to detect the phase difference between the Bluetooth signal received that the various sensors. In particular, insofar as the wavelength at which Bluetooth signals are transmitted are of a magnitude sufficiently close to the distance is being measured, relatively accurate measurements may be made by monitoring the phase difference between signals.

In accordance with the invention, it is also contemplated that module 8 may be programmed to respond to the pattern in the position of cellular telephone 6. For example, movement of the phone from one person to another may signal a distracting situation, even if the driver is not involved. Other situations, based on cellular telephone movement within the vehicle may also signal dangerous conditions which may be used to regulate cellular telephone functionality.

Accordingly, with the invention, real-time information, gathered via modules 8 concerning the position of cellular telephone 6, is used by the inventive vehicular cell phone sensor interface and safety system 2 to determine if it is safe for the cell phone 6 to be active, or, alternatively to determine which functionalities should be disabled.

More particularly, module 8 is responsive to information, 1) respecting the position of the cellular telephone in the car, 2) information indicating whether or not the vehicle is moving, and 3) information respecting whether or not the cell phone is in the vehicle. Systems are disabled only when the vehicle is moving and the cellular telephone is in the vehicle.

If it is determined that it is not safe to use cell phone 6, the vehicular cell phone sensor interface and safety system 2 can send a signal to disable some or all of the functions of cell phone 6.

Referring to FIG. 4, it may be understood how an array of sensors 4 may be positioned around a vehicle in order to define a drivers zone 10. This arrangement would be particularly suited to sensors 4 adapted to detect the strength of the Bluetooth signal from cellular telephone 6.

Additionally, sensors 4 may be positioned around the vehicle in order to define one or more passenger zones 12. By defining several zones in the vehicle, the vehicular cell phone sensor interface and safety system 2 is able to configure each zone with different cell phone use permissions, applying them to cell phone 6 in accordance with system specifications, thus enabling or disabling various functions of cell phone 6 depending on the zone in which cell phone 6 is currently situated. The velocity of the vehicle can also be used to determine which functions of cell phone 6 are safe for use in the various driver zones 10 and passenger zones 12.

For example, in accordance with the invention, a screen shot off command may be sent to the cell phone if the vehicle is moving and if the cellular telephone is in the driver's zone, corresponding to the position of the driver when he is driving the vehicle. This would prevent the driver from texting or using e-mail when the car is moving. In this situation, the system may also disable the telephone's functionality. If speaking is deemed to be a distraction, the cellular telephone may have its telephone (that is speaking) functionality disabled even if it is in a passenger zone. However, it is contemplated that such telephone audio communications functionality will be maintained for a cellular telephone in a passenger zone. However, texting and e-mail functions would always be preserved in the passenger zone, insofar as they are highly likely to present no disturbance to the driver.

Referring to FIG. 5, the relationship between the components comprising vehicular cell phone sensor interface and safety system 2 may be understood. Vehicular cell phone sensor interface and safety system 2 comprises an array of sensors 4 which communicate with each other over a vehicle network 14. The vehicle network 14 functions utilizing wired or wireless technologies, or a combination thereof, in order to link the array of sensors 4 with module 8, cell phone 6 and information from vehicular system 17.

In accordance with the invention, module 8, as noted above, includes a CPU 16 with software for controlling the operation of the inventive system. CPU 16 interprets information detected by the sensors and stores the same, as more fully appears hereinbelow.

In order for the vehicular cell phone sensor interface and safety system 2 to function properly, cell phone 6 must have a number of features, including specialized software for communicating with sensors 4. More particularly, cell phone 6 comprises a transceiver 19 and cell phone data storage device or medium 18, upon which the inventive cell phone software 20 is stored. Cell phone software 20 controls the cell phone 6 to receive a request for a return signal from one of the sensors 4, and in response to that request to transmit a return signal back to the requesting sensor 4. When the return signal is received by sensor for, its amplitude is detected, giving distance information allowing triangulation to be calculated by CPU 16. Such triangulation is enabled by sensor software 30. As noted above, directional systems may also be used.

These signals from sensors 4 thus allow the sensor CPU 16 to send instructions over the particular network to cell phone 6, enabling or disabling features of the cell phone 6. Such enabling or disabling of cell phone features such as text, e-mail, voice communication, and so forth is done by the transmission of Bluetooth signals to cell phone 6. Received Bluetooth signals are sent to cell phone software 20 which controls the operation of cell phone 6. Features of the cell phone 6 are enabled or disabled when the cell phone software 20 makes alterations to the cell phone configuration settings 22 which is also stored on the cell phone data storage medium 18. Settings 22 may be specific protocols specifying those functions which will be enabled or disabled in response to various detected conditions, such as the position of the cell phone 6 in the car while it is moving. More sophisticated variations on control may also be implemented. For example, different protocols may apply at different speeds (which may be determined by GPS information), or different verticals may apply on different types of roads (such as highways versus local streets, or even off the road positions).

While different connection strategies may be employed, in accordance with a preferred embodiment, vehicle systems such as a speedometer may be used to give information. Alternatively, it is contemplated that the inventive system may be coupled to a GPS system. Coupling to vehicle systems, such as the speedometer, tachometer, and the like may be hardwired to module 8. As noted above, communication with the cell phone is done via Bluetooth.

The vehicle network 14 is linked with the vehicle subsystems and facilitates the communication of information between the vehicle systems 24 and the module 8. Central processing computer (CPU) 16 monitors and gathers real-time information and stores it at position 26 in computer storage 28. System software 30 is stored on the computer data storage medium 28 along with sensor configuration settings 32.

The sensor configuration settings 32 comprise the algorithms determining the response of the system to crucial information about the vehicle (such as the vehicle speed, and optionally the vehicle position), and the cell phone position information received from the arrangement of the sensors 4, relating to activity in the driver's zone 10 and the passenger zones 12. The system software 30 allows the module CPU 16 to determine which cell phone 6 features should be enabled or disabled based on the combination of real-time information 26 provided by the vehicle systems 24, the sensor configuration settings 32, and the cell phone position 5 as determined by the array of sensors 4. As alluded to above, software stored on cell phone six response to Bluetooth signals generated by module 8 to implement the desired enablement or disablement of cell phone functions in accordance with the protocols established for the system based on safety considerations.

Referring to FIG. 6, the operation of the vehicular cell phone sensor interface and safety system 2 may be understood.

The system may also be activated when a cell phone equipped with the inventive system comes within range of the vehicle. For example, when a driver gets into a vehicle and starts the engine at step 34, the vehicular cell phone sensor interface and safety system 2 activates the sensor array 4 at step 36. Sensors may also be placed at each entrance to the vehicle. A cellular telephone passing over one of these sensors may be “checked into” that designated zone.

Once activated, the array of sensors 4 are continually scanned for nearby cell phones 6 by means of a scanning process at step 38.

During the scanning process of step 38, the array of sensors 4 provides information which is used for signal triangulation and the system then proceeds to determine if there are any cell phones 6 inside the vehicle which are equipped with the software of the present invention, and further determines the location of those cell phones. If CPU 16 determines that cell phone 6 is not detected inside the vehicle 8, CPU 16 instructs the array of sensors 4 to be scanned again, thus completing a cycle of a range determination process at step 40. As alluded to above, sensors 4 are activated in time sequence. CPU 16 repeats the position determination process at step 40, instructing the array of sensors 4 to continue to return information at step 38 for cell phone 6 until the array of sensors 4 determines that a cell phone 6 is inside the vehicle.

Once a cell phone 6 equipped with the software of the present invention is detected inside the vehicle by the array of sensors 4, the CPU 16 instructs the system to initiate an active triangulation process at step 44 which allows the array of sensors 4 to accurately triangulate and monitor the position of cell phone 6.

Once the triangulation process 44 is complete, CPU 16 initiates a driver's zone determination process at step 46 which provides vehicular cell phone sensor interface and safety system 2 with information indicating whether or not cell phone 6 is inside driver's zone 10. If the driver's zone determination process 46 determines that the cell phone 6 is not currently located within the driver's zone 10, a phone disabled query is sent at step 48 to cell phone 6 through vehicle network 14 from the CPU 16 for the cell phone software 20 to interpret in order to determine whether or not the cell phone 6 is currently disabled. If the cell phone 6 is not disabled, then the sensor computer 16 instructs the scanning process of step 38 to repeat from the beginning. If the phone software 20 informs the phone disabled query 48 that the cell phone 6 is currently disabled, then CPU 16 sends an enable phone signal at step 50, through the vehicle network 14, to the cell phone 6, instructing the cell phone software 20 to enable functionality to the cell phone 6. Once the cell phone 6 has been enabled, CPU 16 instructs the scanning process of step 38 to repeat from the beginning.

If the driver's zone determination process 46 determines that the cell phone 6 is currently located within the drivers zone 10, the sensor computer 16 sends a car moving query at step 52 to the vehicle systems 24 to determine whether or not the vehicle is moving. If the vehicle at step query 52 replies that the vehicle is not moving, a phone disabled query is sent at step 48 to cell phone 6 through the vehicle network 14 from CPU 16 for the cell phone software 20 to interpret in order to determine whether or not the cell phone 6 is currently disabled. If the cell phone 6 is not disabled, then CPU 16 instructs the scanning process of step 38 to repeat from the beginning. If the phone software 20 informs the phone disabled query at step 48 that the cell phone 6 is currently disabled, then the sensor computer 16 sends an enable phone signal at step 50, through the vehicle network 14, to the cell phone 6, instructing the cell phone software 20 to enable functionality to the cell phone 6. Once the cell phone 6 has been enabled, CPU 16 instructs the scanning process 38 to repeat from the beginning.

If the driver's zone determination process 46 determines that the cell phone 6 is currently located within the driver's zone 10, the sensor computer 16 sends a car moving query at step 52 to the vehicle systems 24 to determine whether or not the vehicle 8 is moving, and if the vehicle query of step 52 replies that the vehicle is moving, then a phone disabled query is sent at step 48 to the cell phone 6 through the vehicle network 14 from CPU 16 for the cell phone software 20 to interpret in order to determine whether or not the cell phone 6 is currently disabled. If the cell phone 6 is currently disabled, then the sensor computer 16 instructs the scanning process of step 38 to repeat from the beginning. If the phone software 20 informs in response to the phone disabled query of step 48 that the cell phone 6 is not currently disabled, then the sensor computer 16 sends a disable phone signal 54, through the vehicle network 14, to the cell phone 6, instructing the cell phone software 20 to disable functionality to the cell phone 6. Once the cell phone 6 has been disabled, the sensor computer 16 instructs the scanning process of step 38 to repeat from the beginning.

As long as the vehicle is operational, the scanner computer 16 will continue to instruct the scanning process 38 to repeat from the beginning until such time that the vehicle is turned off, or CPU 16 has not located a sensor 4.

In accordance with the invention, the invention is capable of being embodied in various alternative forms. In this application, alternative embodiments are described in the following figures. To the extent possible or practical, corresponding or an analogous or substantially identical components, and method steps, are labeled and/or referred to herein with numbers which are a multiples of 100 different from the applicable elements in the above described embodiment.

Referring to FIG. 7, an alternate cloud based relationship between the system components may be understood. A cloud based system operates much like a local system except that all network traffic is managed by a cellular network 114 instead of a vehicle network 14. Computations and decisions are managed by a cloud sensor computer 116 instead of a sensor computer located within the vehicle. Gathered information is stored on a cloud computer data storage medium 128 which also stores cloud sensor software 130 and a cloud sensor configuration settings 132. Because all information is managed through the cellular network 114, the network 114 can transmit information such as emergency alerts even while cell phone features are otherwise disabled. The cellular network 114 is also able to share information between vehicles about road conditions or weather, and facilitates communication between drivers of different vehicles in cases such as a caravan or business environments.

An alternate cloud based system might function much like the system described in FIG. 6 except that a cellular network link is achieved along with a sensor system activation instead of just enabling the sensor system as described in FIG. 6. Additionally, when a disable phone signal is sent over the cellular network to disable phone features or service, features or service is disabled on a cellular network level as opposed to a local phone level. This operation makes it more difficult to bypass the disable phone command as well as allows features to enable or disable according to the specific laws of any given area as well as allows for the cellular network to consider local road traffic conditions in the decision making process. The cellular network is thus capable of disabling features during busy rush hour conditions while leaving the same features enabled during light traffic conditions.

Turning to FIG. 8, an embodiment of the inventive cell phone safety system 210 is illustrated. System 210 includes a plurality of sensor units 204, which incorporates sensors and Bluetooth transceiver and transducer. Sensor units 204 are coupled to CPU 216. CPU 216 sequentially prompts sensor units 204a through 204n via their respective Bluetooth transducers. In the embodiment of FIG. 8, sensor units 204 are hardwired to CPU 216. When prompted by CPU 216, the prompted sensor unit transmits a Bluetooth signal which is received by the cell phone 206. When prompted, cell phone 206 transmits a signal over Bluetooth channel 209.

The transmitted signal is received by module 208 via a Bluetooth transceiver 219. Transceiver 219 outputs a version of the transmitted signal to detector 221 for demodulation. The demodulated signal which exits detector 221 is passed to an analog-to-digital encoder 223, which outputs a digital signal indicative of the signal strength of the signal received from cell phone Bluetooth transceiver 206. The signal strength is proportional to the distance between cellular telephone 206 and module 208.

As described above, the system may optionally operate based upon information respecting the level of functionality in the cellular telephone (and, for that matter, and/or other information which may be stored locally in cellular telephone 206), and requests for this information may be sent by CPU 216 through Bluetooth transceiver 219 to cell phone 206, which would, in turn, provide this information directly to Bluetooth transceiver 219 over the applicable Bluetooth channel. This information is then be extracted by digital information decoder 239 and furnished to CPU 216.

In accordance with the inventive system it is contemplated that the system may optionally provide prompts to the cell phone, which are directionally oriented, thus causing the cellular telephone 206 to return the signal only when it is in the range. This may be done via Bluetooth channel 209 directly between the sensors and the cellular telephone via the communications links 280 shown in dashed lines. It is noted that in this application, the term “cellular telephone” is meant to apply to various technologies, including smart phones, digital telephones, and so forth, as well as alternative technologies that may come to replace current protocol-based systems.

In accordance with the present invention, it is also contemplated that a single ping may be transmitted to the cellular telephone, and in response to this, the cellular telephone may transmit a single signal, which is simultaneously received by all sensors in the array. The received signal may be decoded at the sensor for amplitude, which indicates distance. This information is then stored by the sensor, and transmitted to the CPU, when the CPU queries the sensor, either wirelessly or via hardwired connection.

If desired, the system illustrated in FIG. 8 may be original equipment installed by the maker of the vehicle. Alternatively, a retrofit system is illustrated in FIG. 9. Such a system would be of particular interest to employers and others operating vehicles as parts of their business, who would want to increase the safety of the system, which they operate before current vehicles are replaced. Such a system 310 would operate in substantially the same manner as the embodiment of FIG. 8, except that hardwired connections may be replaced by Bluetooth connections 380 and 382 between the Bluetooth sensor transceivers 304 and CPU 316.

This distance information is sent to CPU 216, and may be used to triangulate the position of cellular telephone 206. More particularly, CPU 216 utilizes triangulation software 230 to determine the position of the cellular telephone 206. The same is done using standard triangulation, mathematical techniques.

If cellular telephone 206 is found within the driver's zone, or within other zones with respect to which safety protocols apply, the system, using danger assessment software 232 determines which functionality protocols, stored at position 233, will be used to control the operation of cellular telephone 206.

In making this decision, the system may also take into account one or more of such factors as the location of the car provided by GPS 260, information with respect to the operation of the brakes of the vehicle provided by brake information system 262, the speed of the car provided by speedometer 264, engine rev information provided by tachometer 266 and optionally information provided by other instrumentation on the car. Speed and other information may also be provided by GPS 260.

In addition, using GPS information provided by GPS 260, the system may consult a road and traffic database 268 for information respecting the road on which the vehicle is traveling. For example, highways, or local roads with numerous blind curves, or other known road conditions may dictate a higher level of caution and reduced cell phone functionality. Likewise, GPS 260 may also provide traffic and weather data, and this traffic and weather data may also be used to dictate the level of functionality of cell phone 206.

It is noted that in the above discussion, the use of Bluetooth has been disclosed as illustrative of one communications protocol, which is effective in implementing the method and apparatus of the present invention. However, it is noted that other local communications technologies may also be used, such as other RF, infrared, RFID, wifi or near-field communications.

Referring to FIG. 10, in accordance with the invention, it is also possible to put substantially all functionality on software on the mobile cellular device. In accordance with this embodiment, module 408 essentially comprises a transceiver for communicating with cell phone systems. This transceiver is coupled to existing systems on the car. Likewise, the array of sensors 488 comprises a distinct portion of the system, which is in wireless communication with mobile telephone device 406. The remaining components of the system, both hardware and software are all located on the mobile telephone device 406.

It is further noted in accordance with the embodiment of FIG. 10 that mobile telephone device 406 may be a smart phone. Accordingly, it would have complete GPS functionality, and would be capable of operating independent of vehicle instrumentation. Accordingly, the software resident in the smart phone may be limited to software, which detects the distance between the smart phone and each of the sensors in the array of sensors 488. This would represent an extremely economical implementation of the present invention, requiring only the addition of a number of Bluetooth sensors, optionally responsive to signal amplitude information to determine distance (or optionally responsive to phase information to determine distance), and being powered by batteries. All communication with the senses may be via Bluetooth or other suitable communications technology, and all functions may be performed in the smart phone including triangulation, assessment of the danger of the situation involved, and control of cell phone functions.

While illustrative embodiments of the invention have been described, it is noted that various modifications will be apparent to those of ordinary skill in the art in view of the above description and drawings. Such modifications are within the scope of the invention which is limited and defined only by the following claims.

What is claimed:

1. Apparatus for the management of mobile telephone device functionality while said mobile telephone device is located within a vehicle, comprising:
(a) a plurality of wireless sensors, each of said sensors receiving position indicating signals emitted by said mobile telephone device, and emitting signals indicating the position of each sensor relative to said mobile telephone device, said wireless sensors being positioned at different positions in said vehicle;
(b) a transmitter for transmitting a signal to said mobile telephone device, causing said mobile telephone device to transmit said position indicating signals to said sensors;
(c) a processor coupled to receive said signals indicating the position of each sensor relative to said mobile telephone device, said processor comprising a computational logic unit and a data storage device for storing software for computing the position of said mobile telephone device;
(d) a channel coupling said signals indicating the position of each sensor relative to said mobile telephone device, said computational logic unit, whereby said computational logic unit calculates the position of said mobile telephone device in said vehicle;
(e) a signal source generating a signal indicative of the state of operation of said vehicle and coupling the same to said computational logic unit;
(f) a software algorithm resident on a storage device associated with said computational logic unit, said software controlling the functionality of said mobile telephone device in response to the position of said mobile telephone device within said vehicle and the speed of said vehicle.

2. Apparatus as in claim 1, wherein the communication between said computational device and said sensors is wireless.

3. Apparatus as in claim 1, wherein communication between said mobile telephone device and said computational device is via Bluetooth or the equivalent.

4. Apparatus as in claim 1, wherein said sensors communicate with said CPU by Bluetooth.

5. Apparatus as in claim 1, wherein said sensors have directional characteristics and are arranged to define rows and columns in said vehicle, said CPU being responsive to the detection of said mobile telephone device in a row and column to define its position as the intersection of said row and column.

6. Apparatus as in claim 1, wherein said emitted signals indicating the position of each sensor with respect to said mobile telephone device indicate the distance between said sensor and said mobile telephone device, said CPU calculating the position of said mobile telephone device using geometrical triangulation.

7. Apparatus as in claim 1, wherein said set of stores are hardwired to said CPU.

8. Apparatus as in claim 1, wherein said CPU is responsive to danger assessment software resident on a storage device, said danger assessment being responsive to the position of said mobile telephone device and the speed of said vehicle.

9. Apparatus as in claim 1, wherein said CPU is responsive to danger assessment software resident on a storage device, said danger assessment being responsive to the position of said mobile telephone device and the speed of said vehicle, and further responsive to an item selected from the group consisting of the location the vehicle, the nature of the road, and current traffic conditions.

10. Apparatus as in claim 1, wherein said CPU is responsive to danger assessment software resident on a storage device, said danger assessment being responsive to the position of said mobile telephone device and the speed of said vehicle, and further responsive to an item selected from the group consisting of the location the vehicle, the nature of the road, and current traffic conditions, and yet further responsive to an item selected from the group consisting of brake use and engine revolutions from it.

11. Apparatus as in claim 1, wherein the processor is located in the mobile telephone device.

12. A method for the management of mobile telephone device functionality while said mobile telephone device is located within a vehicle, comprising:
(a) monitoring a plurality of wireless sensors, each of said sensors receiving position indicating signals emitted by said mobile telephone device, and emitting signals indicating the position of each sensor relative to said mobile telephone device, said wireless sensors being positioned at different positions in said vehicle;
(b) transmitting a signal to said mobile telephone device with a transmitter, causing said mobile telephone device to transmit said position indicating signals to said sensors;
(c) sending said signals indicating the position of each sensor relative to said mobile telephone device to a processor, said processor, providing computational logic and storing data and storing software for computing the position of said mobile telephone device;
(d) receiving said signals indicating the position of each sensor relative to said mobile telephone device, and calculating the position of said mobile telephone device in said vehicle;
(e) generating a signal indicative of the state of operation of said vehicle;
(f) executing a software algorithm resident on a storage device, said software controlling the functionality of said mobile telephone device in response to the position of said mobile telephone device within said vehicle and the speed of said vehicle.
